(19) United States
(12) Patent Application Publication
(10) Pub. No.: US 2018/0285642 A1
(43) Pub. Date: Oct. 4, 2018

(54) Head Mounted Display

(71) Applicant: Seiko Epson Corporation, Tokyo (JP)

(72) Inventor: Teruyuki NISHIMURA, Matsumoto (JP)

(21) Appl. No.: 15/920,882

(22) Filed: Mar. 14, 2018

(30) Foreign Application Priority Data
Mar. 29, 2017 (JP) 2017-064544

(51) Int. Cl. G06K 9/00; G06T 11/60; G06T 7/73; G01J 3/28; G01J 3/12

(52) U.S. Cl. CPC G06K 9/00671; G06T 11/60; G01J 3/12; G01J 3/2823; G06T 7/74

(57) ABSTRACT

A head mounted display mountable on the head of a user includes a pupil detecting section configured to detect pupil positions of the user in a state in which the head mounted display is mounted, a line-of-sight specifying section configured to specify a line-of-sight direction of the user on the basis of the pupil positions, a spectral measurement section configured to acquire spectral measurement information of at least a part of a scene within a visual field of the user in the state in which the head mounted display is mounted, a target-object-information acquiring section configured to acquire target object information concerning a first target object in the line-of-sight direction on the basis of the spectral measurement information, and a display section configured to display the target object information in a position corresponding to the first target object in the scene.

### BACKGROUND

### 1. Technical Field

The present invention relates to a head mounted display.

### 2. Related Art

There has been known a head mounted display mounted on the head of a user (see, for example, JP-A-2015-177397 (Patent Literature 1)).

The head mounted display described in Patent Literature 1 superimposes and displays, on the visual field of the user (a disposition position of eyeglass lenses), external light of a scene within a visual field direction and video light of an image to be displayed.

Specifically, the head mounted display includes a substance sensor that images the scene in the visual field direction. The substance sensor disperses incident light with a variable wavelength interference filter such as an etalon and detects received light amounts of the dispersed lights. The head mounted display causes a display section to display various kinds of information analyzed on the basis of received light amounts of spectral wavelengths obtained by the substance sensor and performs augmented reality (AR) display.

Incidentally, the head mounted display described in Patent Literature 1 described above causes the display section, which is capable of performing the AR display, to display spectral information acquired by the substance sensor and various kinds of information based on the spectral information over the entire display section.

However, in this case, a processing load of various kinds of processing involved in the analysis and the display of the spectral information are applied. Various kinds of information concerning not only a work target of the user but also a target around the work target are sometimes displayed. The various kinds of information concerning the work target are less easily seen. Therefore, there is a demand for a head mounted display capable of quickly and appropriately AR-displaying the various kinds of information concerning the work target of the user.

### SUMMARY

An advantage of some aspects of the invention is to provide a head mounted display capable of quickly and appropriately AR-displaying various kinds of information concerning a work target of a user.

A head mounted display according to an application example of the invention is a head mounted display mountable on a head of a user. The head mounted display includes: a pupil detecting section (pupil detecting sensor) configured to detect pupil positions of the user in a state in which the head mounted display is mounted; a line-of-sight specifying section configured to specify a line-of-sight direction of the user on the basis of the pupil positions; a spectral measurement section (spectral measurer) configured to acquire spectral measurement information of at least a part of a scene within a visual field of the user in the state in which the head mounted display is mounted; a target-object-information acquiring section configured to acquire first target object information concerning a first target object in the scene on the basis of the spectral measurement information; and a display section configured to display the first target object information in a position corresponding to the first target object in the scene. Specifying the line-of-sight and acquiring the target object information are performed by a control section (controller) that includes the line-of-sight specifying section and the target-object-information acquisition section.

In this application example, the head mounted display detects the pupil positions of the user with the pupil-position detecting section and specifies, with the line-of-sight specifying section, the line-of-sight direction based on the pupil positions of the user. The head mounted display disperses, with the spectral measurement section (spectral measurer), external light in a part of a range in the visual field of the user and acquires the spectral measurement information. The target-object-information acquiring section acquires the first target object information concerning the first target object in the scene within the visual field of the user from the obtained spectral measurement information. The display section superimposes and displays the first target object information on the first target object in the scene of the external light within the visual field of the user. That is, in this application example, the target object information concerning the first target object (a work target of the user) present in the line-of-sight direction of the user in the visual field of the user is AR-displayed. A target object around the first target object is not AR-displayed.

In this case, the target object to be AR-displayed is the first target object. The target-object-information acquiring section only has to analyze spectral measurement information of the first target object from the spectral measurement information and acquire target object information. Therefore, it is unnecessary to acquire target object information concerning the target object disposed around the first target object. It is possible to reduce a processing load and perform quick AR display processing.

The display section performs the AR display for the first target object present in the line-of-sight direction within the visual field of the user. Therefore, the target object information concerning the first target object, which is the work target, is easily seen. It is possible to cause the user to appropriately confirm the target object information.

Consequently, in this application example, it is possible to quickly and appropriately AR-display various kinds of information concerning the work target of the user.

In the head mounted display according to the application example, it is preferable that the spectral measurement section (spectral measurer) acquires the spectral measurement information in a predetermined range of the scene, the target-object-information acquiring section acquires second target object information concerning a second target object included in the predetermined range, and the display section displays the first target object information in the position corresponding to the first target object and thereafter displays, according to elapse of time, the second target object information in a position corresponding to the second target object in the scene.

In the application example with this configuration, the target-object-information acquiring section acquires target object information in a predetermined range in the line-of-sight direction. First, the display section displays the first target object information concerning the first target object present in the line-of-sight direction. Thereafter the display section displays, according to the elapse of time, target object information concerning another target object within the predetermined range present around the first target object.

Consequently, the user can also confirm the target object information concerning the other target object around the first target object (the work target). It is possible to further improve the work efficiency of the user. Even when the line-of-sight direction of the user and the work target deviate from each other, the target object information concerning the work target is displayed according to the elapse of time. It is possible to appropriately display the target object information concerning the work target needed by the user.

In the head mounted display according to the application example, it is preferable that the spectral measurement section (spectral measurer) includes a spectral element adapted to disperse incident light and capable of changing a spectral wavelength and an imaging section (imager) configured to image lights dispersed by the spectral element and obtain spectral images as the spectral measurement information, and the head mounted display further includes: a deviation detecting section configured to detect deviation amounts of imaging positions at times when the spectral wavelength is sequentially switched by the spectral element; and a spectral-image correcting section configured to correct the deviation amounts in the spectral images having a plurality of wavelengths. The deviation detecting section and the spatial-image correcting section are included in the control section (controller).

Incidentally, in the head mounted display, when the spectral measurement section (spectral measurer) sequentially switches a plurality of spectral wavelengths and images split lights, a time difference occurs in acquisition timings of the spectral images. At this time, when the head of the user, on which the head mounted display is mounted, swings or moves, imaging ranges of the spectral images are ranges different from one another (positional deviation occurs). On the other hand, in the application example with the configuration described above, the deviation detecting section detects positional deviation amounts of the spectral images. The spectral-image correcting section corrects positional deviation of the spectral images. Consequently, in the application example with the configuration described above, the first target object in the scene within the visual field of the user does not deviate in the spectral images. It is possible to obtain proper spectral measurement information concerning the first target object.

In the head mounted display according to the application example, it is preferable that the head mounted display includes an RGB camera configured to image the scene, and the deviation detecting section detects the deviation amounts from positions of feature points of RGB images captured by the RGB camera at timings when the spectral images are acquired.

In the application example with this configuration, the scene by the external light from the visual field of the user is imaged. The deviation amounts from the positions of the feature points of the captured images (the RGB images) are detected. Examples of the feature points include edge portions where luminance values of pixels adjacent to each other fluctuate by a predetermined value or more in the RGB images. When the feature points in the spectral images are extracted using only the spectral images, for example, an edge portion (a feature point) detected in a red image is sometimes not detected in a blue image. On the other hand, when the feature points are detected on the basis of the RGB images, it is possible to detect the feature points within a wide wavelength region of a visible wavelength region. Therefore, for example, if a plurality of feature points are detected and corresponding feature points of the spectral images are detected, it is possible to easily detect the deviation amounts of the spectral images.

In the head mounted display according to the application example, it is preferable that the head mounted display includes a displacement detection sensor adapted to detect displacement of a position of the head mounted display, and the deviation detecting section detects the deviation amounts on the basis of a displacement amount detected by the displacement detection sensor.

In the application example with this configuration, the displacement amount of the position of the head mounted display is detected by the displacement detection sensor provided in the head mounted display. In this case, by detecting a displacement amount of the position of the head mounted display at acquisition timings of the spectral images, it is possible to easily calculate the positional deviation amounts of the spectral images.

### BRIEF DESCRIPTION OF THE DRAWINGS

The invention will be described with reference to the accompanying drawings, wherein like numbers reference like elements.

FIG. 1 is a perspective view showing a head mounted display according to the first embodiment.

FIG. 2 is a block diagram showing a schematic configuration of the head mounted display according to the first embodiment.

FIG. 3 is a diagram showing a schematic configuration of a spectral camera in the first embodiment.

FIG. 4 is a flowchart for explaining a flow of AR display processing in the first embodiment.

FIG. 5 is a diagram showing an example of a range in which AR display is performed in the first embodiment.

FIG. 6 is a diagram showing an example of an image displayed in the AR display processing in the first embodiment.

FIG. 7 is a diagram showing an example of an image displayed in the AR display processing in the first embodiment.

### DESCRIPTION OF EXEMPLARY EMBODIMENTS

### First Embodiment

A first embodiment is explained below.

### Schematic Configuration of a Head Mounted Display

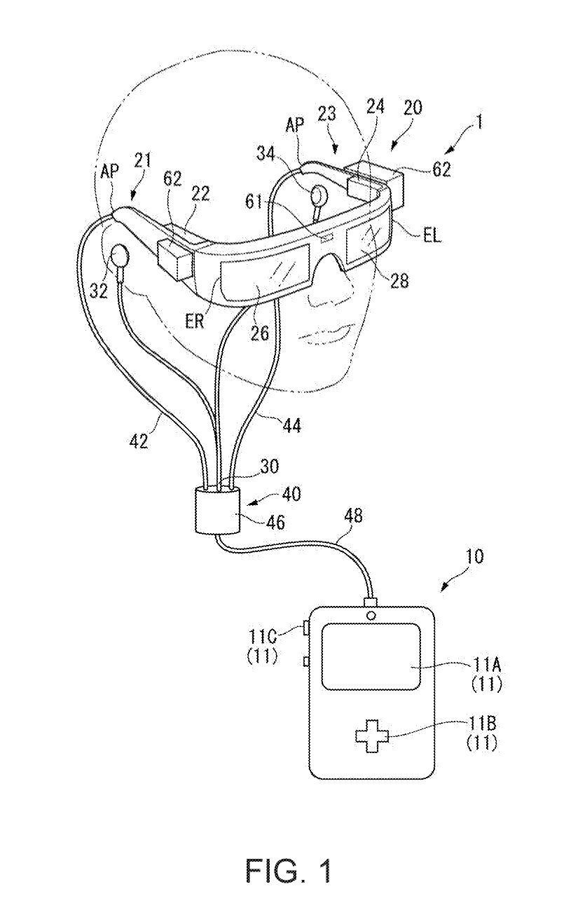

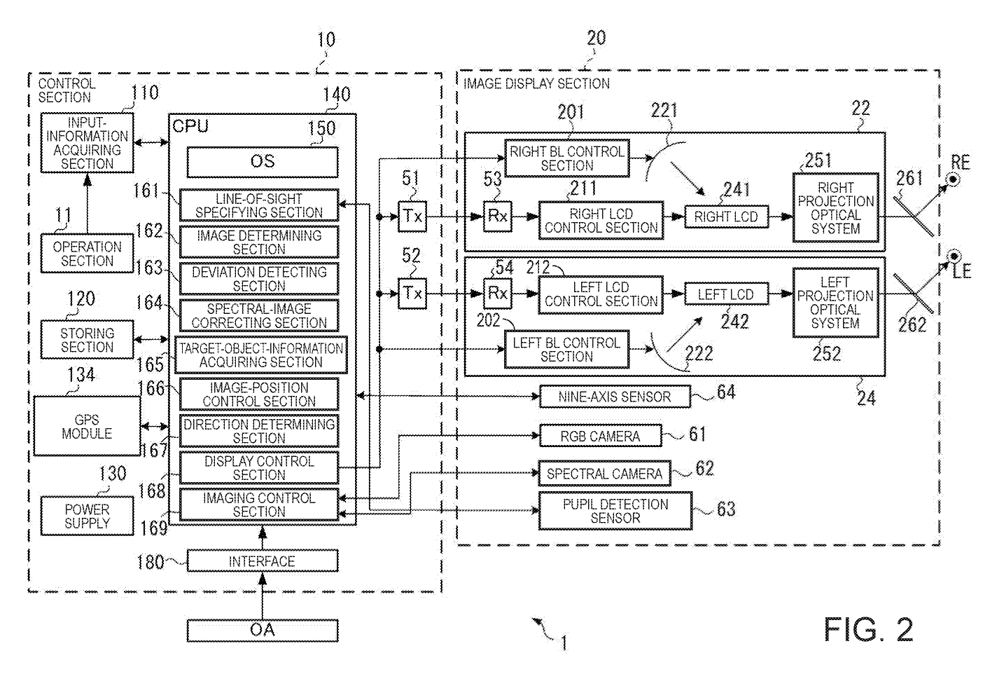

FIG. 1 is a perspective view showing a head mounted display according to the first embodiment. FIG. 2 is a block diagram showing a schematic configuration of the head mounted display.

As shown in FIG. 1, the head mounted display (hereinafter abbreviated as HMD 1) according to this embodiment is a head-mounted display device mountable on the head of a user or a mounting part such as a helmet (in detail, a position corresponding to an upper portion of the head including the frontal region and the temporal region). The HMD 1 is a head-mounted display device of a see-through type that displays a virtual image to be visually recognizable by the user and transmits external light to enable observation of a scene in the outside world (an outside scene).

Note that, in the following explanation, the virtual image visually recognized by the user using the HMD 1 is referred to as “display image” as well for convenience. Emitting image light generated on the basis of image information is referred to as “display an image” as well.

The HMD 1 includes an image display section 20 that causes the user to visually recognize the virtual image in a state in which the HMD 1 is mounted on the head of the user and a control section (controller) 10 that controls the image display section 20.

### Configuration of the Image Display Section 20

The image display section 20 is a mounted body mounted on the head of the user. In this embodiment, the image display section 20 has an eyeglass shape. “Mounted on the head of the user” includes “mounted on the head of the user via a helmet or the like”. The image display section 20 includes a right holding section 21, a right display driving section 22, a left holding section 23, a left display driving section 24, a right optical-image display section 26, a left optical-image display section 28, an RGB camera 61, a spectral camera 62, pupil detection sensors 63, and a nine-axis sensor 64.

The right optical-image display section 26 and the left optical-image display section 28 are respectively arranged to be located in front of the right and left eyes of the user when the user wears the image display section 20. One end of the right optical-image display section 26 and one end of the left optical-image display section 28 are connected to each other in a position corresponding to the middle of the forehead of the user when the user wears the image display section 20.

Note that, in the following explanation, the right holding section 21 and the left holding section 23 are collectively simply referred to as “holding section” as well, the right display driving section 22 and the left display driving section 24 are collectively simply referred to as “display driving section” as well, and the right optical-image display section 26 and the left optical-image display section are collectively simply referred to as “optical-image display section” as well.

The right holding section 21 is a member provided to extend from an end portion ER, which is the other end of the right optical-image display section 26, to a position corresponding to the temporal region of the user when the user wears the image display section 20. Similarly, the left holding section 23 is a member provided to extend from an end portion EL, which is the other end of the left optical-image display section 28, to a position corresponding to the temporal region of the user when the user wears the image display section 20. The right holding section 21 and the left holding section 23 hold the image display section 20 on the head of the user in the same manner as temples of eyeglasses.

The display driving sections 22 and 24 are disposed to be opposed to the head of the user when the user wears the image display section 20. The display driving sections 22 and 24 include, as shown in FIG. 2, liquid crystal displays (LCDs 241 and 242) and projection optical systems 251 and 252.

More specifically, the right display driving section 22 includes, as shown in FIG. 2, a receiving section (Rx) 53, a right backlight control section (a right BL control section 201) and a right backlight (a right BL 221) functioning as a light source, a right LCD control section 211 and a right LCD 241 functioning as a display element, and a right projection optical system 251.

The right BL control section 201 and the right BL 221 function as the light source. The right LCD control section 211 and the right LCD 241 function as the display element. Note that the right BL control section 201, the right LCD control section 211, the right BL 221, and the right LCD 241 are collectively referred to as “image-light generating section” as well.

The Rx 53 functions as a receiver for serial transmission between the control section 10 and the image display section 20. The right BL control section 201 drives the right BL 221 on the basis of an input control signal. The right BL 221 is, for example, a light emitting body such as an LED or an electroluminescence (EL). The right LCD control section 211 drives the right LCD 241 on the basis of a clock signal PCLK, a vertical synchronization signal VSync, a horizontal synchronization signal HSync, and image information for right eye input via the Rx 53. The right LCD 241 is a transmissive liquid crystal panel on which a plurality of pixels are arranged in a matrix shape.

The right projection optical system 251 is configured by a collimate lens that changes image light emitted from the right LCD 241 to light beams in a parallel state. A right light guide plate 261 functioning as the right optical-image display section 26 guides the image light output from the right projection optical system 251 to a right eye RE of the user while reflecting the image light along a predetermined optical path. Note that the right projection optical system 251 and the right light guide plate 261 are collectively referred to as “light guide section” as well.

The left display driving section 24 includes the same configuration as the configuration of the right display driving section 22. The left display driving section 24 includes a receiving section (Rx 54), a left backlight control section (a left BL control section 202) and a left backlight (a left BL 222) functioning as alight source, a left LCD control section 212 and a left LCD 242 functioning as a display element, and a left projection optical system 252. The left BL control section 202 and the left BL 222 function as the light source. The left LCD control section 212 and the left LCD 242 function as the display element. Note that the left BL control section 202, the left LCD control section 212, the left BL 222, and the left LCD 242 are collectively referred to as “image-light generating section” as well. The left projection optical system 252 is configured by a collimate lens that changes image light emitted from the left LCD 242 to light beams in a parallel state. A left light guide plate 262 functioning as the left optical-image display section 28 guides the image light output from the left projection optical system 252 to a left eye LE of the user while reflecting the image light along a predetermined optical path. Note that the left projection optical system 252 and the left light guide plate 262 are collectively referred to as “light guide section” as well.

The optical-image display sections 26 and 28 include light guide plates 261 and 262 (see FIG. 2) and dimming plates. The light guide plates 261 and 262 are formed of a light transmissive resin material or the like and guide image lights output from the display driving sections 22 and 24 to the eyes of the user. The dimming plates are thin plate-like optical elements and arranged to cover the front side of the image display section 20, which is a side opposite to the side of the eyes of the user. The dimming plates protect the light guide plates 261 and 262 and suppresses damage, adhesion of stain, and the like to the light guide plates 261 and 262. By adjusting the light transmittance of the dimming plates, it is possible to adjust an amount of external light entering the eyes of the user and adjust easiness of visual recognition of a virtual image. Note that the dimming plates can be omitted.

The RGB camera 61 is disposed in, for example, a position corresponding to the middle of the forehead of the user when the user wears the image display section 20. Therefore, the RGB camera 61 images an outside scene, which is a scene within the visual field of the user, and acquires an outside scene image in a state in which the user wears the image display section 20 on the head.

The RGB camera 61 is an imaging device in which R light receiving elements that receive red light, G light receiving elements that receive green light, and B light receiving elements that receive blue light are arranged in, for example, a Bayer array. An image sensor of a CCD, a CMOS, or the like can be used as the RGB camera 61.

Note that the RGB camera 61 shown in FIG. 1 is a monocular camera. However, the RGB camera 61 may be a stereo camera.

The spectral camera 62 acquires spectral images including at least apart of the visual field of the user. Note that, in this embodiment, an acquisition region of the spectral images is within the same range as the RGB camera 61. The spectral camera 62 acquires spectral images with respect to an outside scene within the visual field of the user.

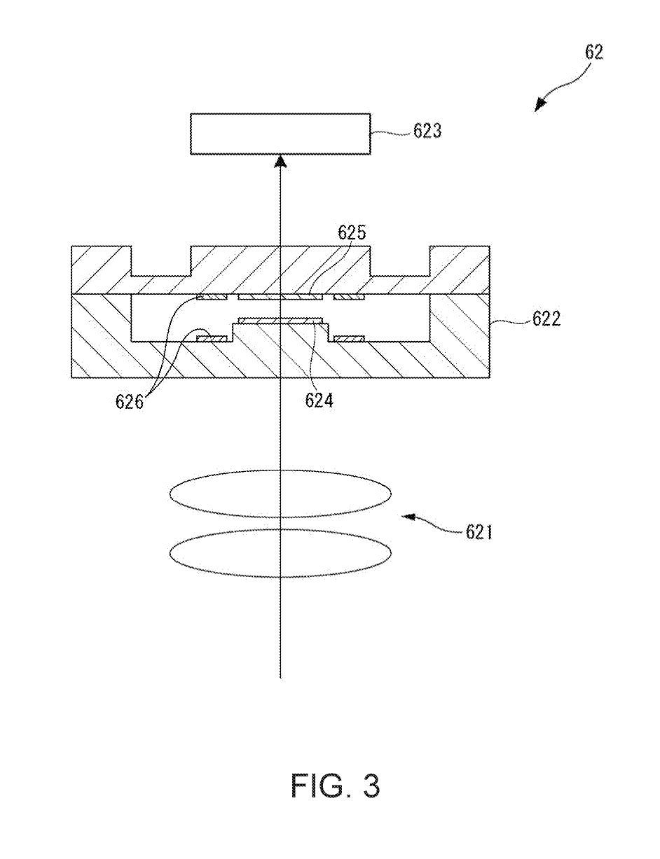

FIG. 3 is a diagram showing a schematic configuration of the spectral camera 62.

The spectral camera 62 includes, as shown in FIG. 3, an incident optical system 621 on which external light is made incident, a spectral element 622 that disperses the incident light, and an imaging section 623 that images the light split by the spectral element 622.

The incident optical system 621 is configured by, for example, a telecentric optical system and guides the incident light to the spectral element 622 and the imaging section (imager) 623 such that an optical axis and a principal ray are parallel or substantially parallel.

The spectral element 622 is a variable wavelength interference filter (a so-called etalon) including, as shown in FIG. 3, a pair of reflection films 624 and 625 opposed to each other and gap changing sections 626 (e.g., electrostatic actuators) capable of changing the distance between the reflection films 624 and 625. A voltage applied to the gap changing sections 626 is controlled, whereby the spectral element 622 is capable of changing a wavelength (a spectral wavelength) of light transmitted through the reflection films 624 and 625.

The imaging section 623 is a device that images image light transmitted through the spectral element 622. The imaging section 623 is configured by an image sensor of a CCD, a CMOS, or the like.

Note that, in this embodiment, as an example, the spectral camera 62 is a stereo camera provided in the holding sections 21 and 23. However, the spectral camera 62 may be a monocular camera. When the spectral camera 62 is the monocular camera, for example, it is desirable to dispose the monocular camera between the optical-image display sections 26 and 28 (in substantially the same position as the RGB camera 61).

The spectral camera 62 is equivalent to the spectral measurement section (spectral measurer). The spectral camera 62 sequentially switches a spectral wavelength of lights split by the spectral element 622 and captures spectral images with the imaging section 623. That is, the spectral camera 62 outputs a plurality of spectral images corresponding to a plurality of spectral wavelengths to the control section 10 as spectral measurement information.

The pupil detection sensors 63 are equivalent to the pupil detecting section and provided, for example, on a side opposed to the user in the optical-image display sections 26 and 28. The pupil detection sensors 63 include image sensors of a CCD or the like. The pupil detection sensors 63 image the eyes of the user and detect the positions of the pupils of the user.

As the detection of the pupil positions, for example, an infrared ray is irradiated on the eyes of the user and the positions of the infrared ray reflected on the corneas and the pupils corresponding to the reflection positions of the infrared ray (positions where a luminance value is the smallest) are detected. Note that the detection of the pupil positions is not limited to this. For example, positions of the pupils or the irises with respect to predetermined positions (e.g., eyelids, eyebrows, inner corners of the eyes, or ends of the eyes) in a captured image of the eyes of the user may be detected.

The nine-axis sensor 64 is equivalent to the displacement detection sensor and is a motion sensor that detects acceleration (three axes), angular velocity (three axes), and terrestrial magnetism (three axes). The nine-axis sensor 64 is provided in the image display section 20. Therefore, when the image display section 20 is worn on the head of the user, the nine-axis sensor 64 detects a movement of the head of the user. The direction of the image display section 20 is specified from the detected movement of the head of the user.

The image display section 20 includes a connecting section 40 for connecting the image display section 20 to the control section 10. The connecting section 40 includes a main body cord 48 connected to the control section 10, a right cord 42, a left cord 44, and a coupling member 46. The right cord 42 and the left cord 44 are two cords branching from the main body cord 48. The right cord 42 is inserted into a housing of the right holding section 21 from a distal end portion AP in an extending direction of the right holding section 21 and connected to the right display driving section 22. Similarly, the left cord 44 is inserted into a housing of the left holding section 23 from a distal end portion AP in an extending direction of the left holding section 23 and connected to the left display driving section 24. The coupling member 46 includes a jack provided in a branching point of the main body cord 48 and the right and left cords 42 and 44 to connect an earphone plug 30. A right earphone 32 and a left earphone 34 extend from the earphone plug 30.

The image display section 20 and the control section 10 perform transmission of various signals via the connecting section 40. Connectors (not shown in the figure), which fit with each other, are respectively provided at an end portion of the main body cord 48 on the opposite side of the coupling member 46 and in the control section 10. The control section and the image display section 20 are connected and disconnected according to fitting and unfitting of the connector of the main body cord 48 and the connector of the control section 10. For example, a metal cable or an optical fiber can be adopted as the right cord 42, the left cord 44, and the main body cord 48.

Note that, in this embodiment, an example is explained in which the image display section 20 and the control section 10 are connected by wire. However, the image display section 20 and the control section 10 may be wirelessly connected using, for example, a wireless LAN or a Bluetooth (registered trademark).

### Configuration of the Control Section 10

The control section 10 is a device for controlling the HMD 1. The control section 10 includes an operation section 11 including, for example, a track pad 11A, a direction key 11B, and a power switch 11C.

The control section 10 includes, as shown in FIG. 2, an input-information acquiring section 110, a storing section 120, a power supply 130, the operation section 11, a CPU 140, an interface 180, transmitting sections (Tx 51 and Tx 52), and a GPS module 134.

The input-information acquiring section 110 acquires a signal corresponding to an operation input of the operation section 11 by the user.

The storing section 120 has stored therein various computer programs. The storing section 120 is configured by a ROM, a RAM, and the like.

The GPS module 134 receives signals from GPS satellites to thereby specify a present position of the image display section 20 and generates information indicating the position. Since the present position of the image display section 20 is specified, a present position of the user of the HMD 1 is specified.

The interface 180 is an interface for connecting various external apparatuses OA, which are supply sources of contents, to the control section 10. Examples of the external apparatuses OA include a personal computer (PC), a cellular phone terminal, and a game terminal. As the interface 180, for example, a USB interface, a micro USB interface, and a memory card interface can be used.

The CPU 140 reads out and executes the computer programs stored in the storing section 120 to thereby function as an operating system (OS 150), a line-of-sight specifying section 161, an image determining section 162, a deviation detecting section 163, a spectral-image correcting section 164, a target-object-information acquiring section 165, an image-position control section 166, a direction determining section 167, a display control section 168, and an imaging control section 169.

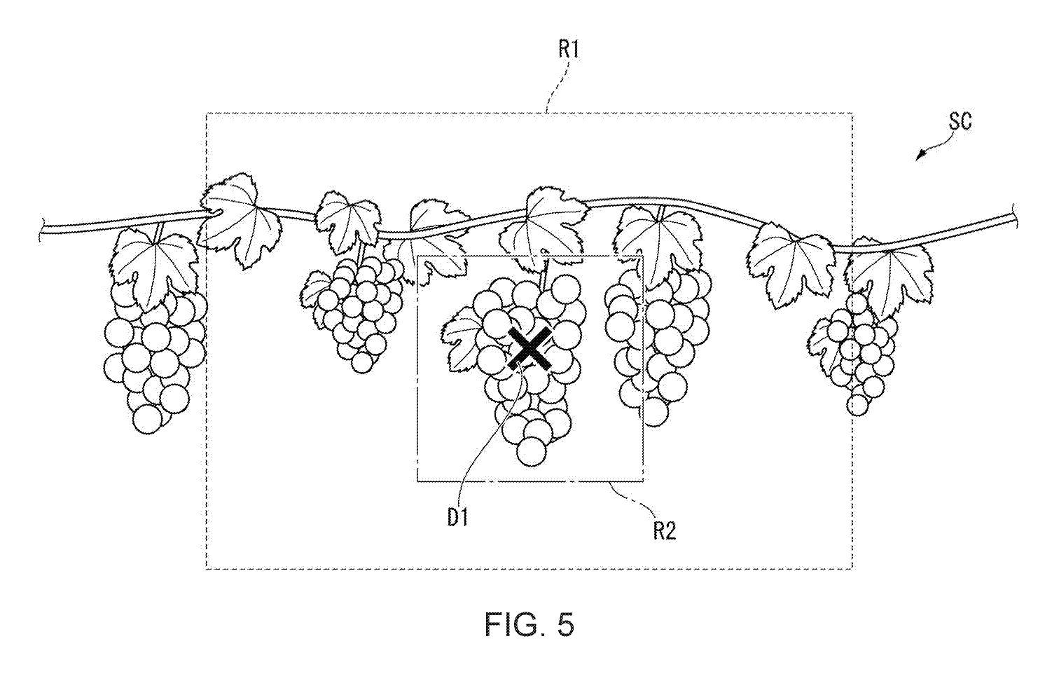

The line-of-sight specifying section 161 specifies a line-of-sight direction D1 (see FIG. 5) of the user on the basis of pupil positions (the positions of the pupils) of the left and right eyes of the user detected by the pupil detection sensors 63.

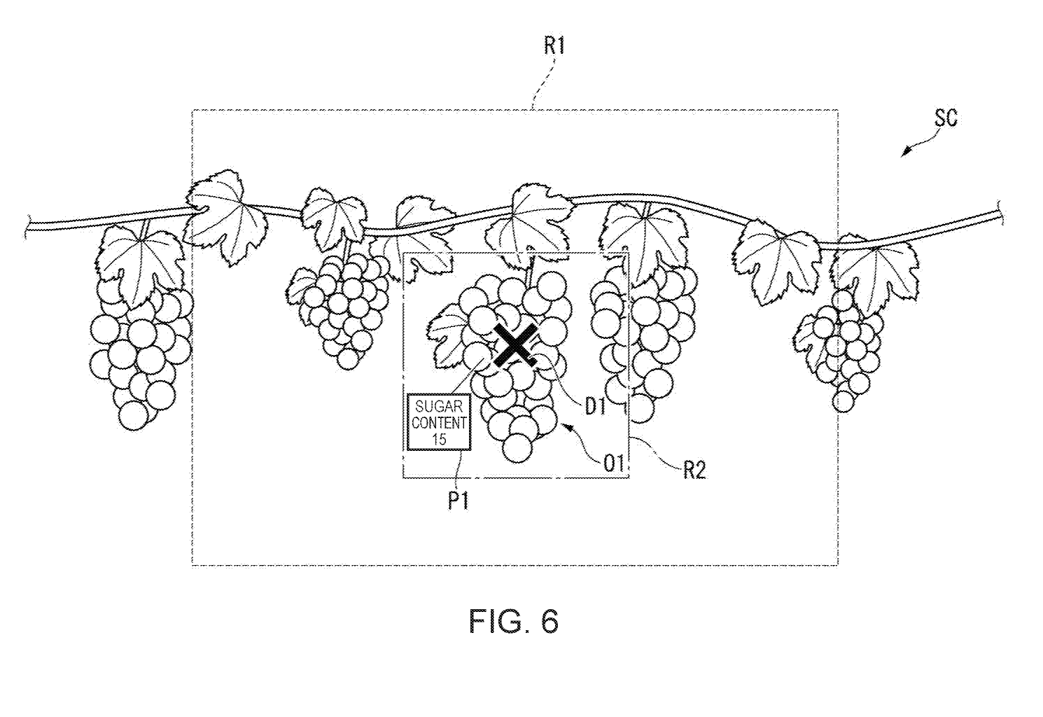

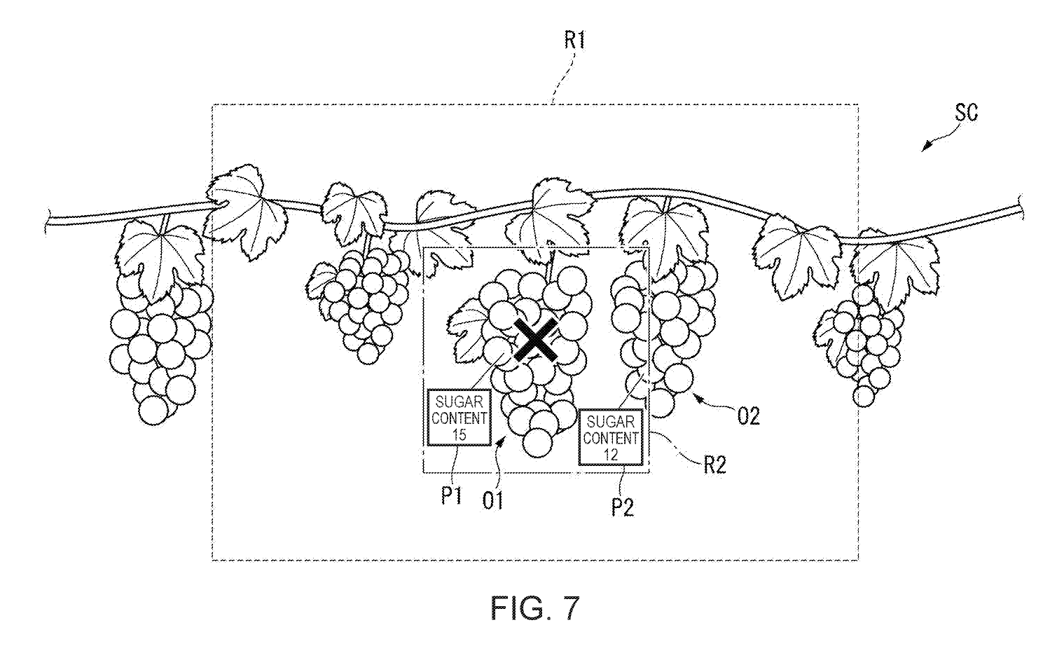

The image determining section 162 determines according to pattern matching, for example, whether the same specific target object as image information of a specific target object stored in advance in the storing section 120 is included in an outside scene image. When the specific target object is included in the outside scene image, the image determining section 162 determines whether the specific target object is located on the line-of-sight direction. That is, the image determining section 162 determines the specific target object located on the line-of-sight direction as a first target object O1 (see FIGS. 6 and 7).

The deviation detecting section 163 detects deviation amounts of imaging positions (pixel positions) among spectral images.

In this embodiment, since spectral images are captured by sequentially switching a spectral wavelength, the head position of the user wearing the HMD 1 sometimes changes at imaging timings of the spectral images. Imaging ranges R1 (see FIGS. 5 to 7) of the spectral images are ranges different from one another. Therefore, the deviation detecting section 163 detects deviation amounts of the imaging ranges R1 of the spectral images.

In this embodiment, outside scene images are captured by the RGB camera 61 at timings when spectral images having the respective wavelengths are captured by the spectral camera 62. The deviation detecting section 163 detects deviation amounts of the spectral images on the basis of the outside scene images captured simultaneously with the spectral images.

The deviation detecting section 163 may calculate positional deviation amounts between the outside scene image captured by the RGB camera 61 and the spectral images captured as explained above. That is, the deviation detecting section 163 detects feature points in a currently captured outside scene image and compares the detected feature points and feature points of the outside scenes at timings when the spectral images are captured to thereby calculate deviation amounts between the spectral images and the currently-captured outside scene image.

The spectral-image correcting section 164 corrects pixel positions of the spectral images on the basis of the calculated positional deviation amounts of the spectral images. That is, the spectral-image correcting section 164 adjusts the pixel positions of the spectral images to match the feature points of the spectral images.

The target-object-information acquiring section 165 acquires analysis information of the target object (target object information) on the basis of the spectral measurement information (the spectral images corresponding to the plurality of wavelengths) obtained by the spectral camera 62. The target-object-information acquiring section 165 can acquire target object information corresponding to items chosen by the user. For example, when the user chooses display of a sugar content of a target object (a food, etc.), the target-object-information acquiring section 165 analyzes spectral measurement information corresponding to the target object included in an outside scene image and calculates the sugar content included in the target object as target object information. For example, when the user chooses superimposition of a spectral image having a predetermined wavelength on the target object, the target-object-information acquiring section 165 extracts, from the spectral images, the same pixel region as a pixel region corresponding to the target object included in the outside scene and sets the pixel region as target object information.

In this case, first, the target-object-information acquiring section 165 acquires target object information corresponding to the first target object O1 specified by the image determining section 162. Subsequently, the target-object-information acquiring section 165 acquires target object information within a predetermined range (an extended range R2: see FIGS. 5 to 7) set in advance centering on the line-of-sight direction D1.

When a specific target object is included in the outside scene image, the image-position control section 166 causes the image display section 20 to display image information indicating target object information concerning the specific target object. For example, the image-position control section 166 specifies, from the outside scene image, a position coordinate of the first target object O1 located in the line-of-sight direction D1 and superimposes and displays the image information indicating the target object information in a position overlapping the first target object O1 or in the vicinity of the first target object O1.

The image-position control section 166 may create image information in which RGB values are changed according to colors (RGB values) of the outside scene image or change the luminance of the image display section 20 according to the luminance of the outside scene image to generate different images on the basis of the same image information. For example, as the distance from the user to the specific target object is closer, the image-position control section 166 creates image information in which characters included therein are larger. As the luminance of the outside scene image is lower, the image-position control section 166 sets the luminance of the image display section 20 smaller.

The direction determining section 167 determines a direction and a movement and a displacement amount (a movement amount) of a position of the image display section 20 detected by the nine-axis sensor 64 explained below. The direction determining section 167 determines the direction of the image display section 20 to estimate the direction of the head of the user.

The display control section 168 generates control signals for controlling the right display driving section 22 and the left display driving section 24 and causes the right display driving section 22 and the left display driving section 24 to display image information in a position set by the image-position control section 166. Specifically, the display control section 168 individually controls, with control signals, ON/OFF of driving of the right LCD 241 by the right LCD control section 211, ON/OFF of driving of the right BL 221 by the right BL control section 201, ON/OFF of driving of the left LCD 242 by the left LCD control section 212, and ON/OFF of driving of the left BL 222 by the left BL control section 202 to thereby control generation and emission of image lights respectively by the right display driving section 22 and the left display driving section 24. For example, the display control section 168 causes both of the right display driving section 22 and the left display driving section 24 to generate image lights, causes only one of the right display driving section 22 and the left display driving section 24 to generate image light, or does not cause both of the right display driving section 22 and the left display driving section 24 to generate image lights.

At this time, the display control section 168 transmits respective control signals for the right LCD control section 211 and the left LCD control section 212 to the image display section 20 via the Tx 51 and the Tx 52. The display control section 168 transmits respective control signals for the right BL control section 201 and the left BL control section 202.

The imaging control section 169 controls the RGB camera 61 and the spectral camera 62 to acquire a captured image. That is, the imaging control section 169 starts the RGB camera 61 and causes the RGB camera 61 to capture an outside scene image. The imaging control section 169 applies a voltage corresponding to a predetermined spectral wavelength to the spectral element 622 (the gap changing sections 626) of the spectral camera 62 and causes the spectral element 622 to split light having the spectral wavelength. The imaging control section 169 controls the imaging section 623 to image the light having the spectral wavelength and acquires spectral images.

### Image Display Processing of the HMD 1

AR display processing in the HMD 1 explained above is explained.

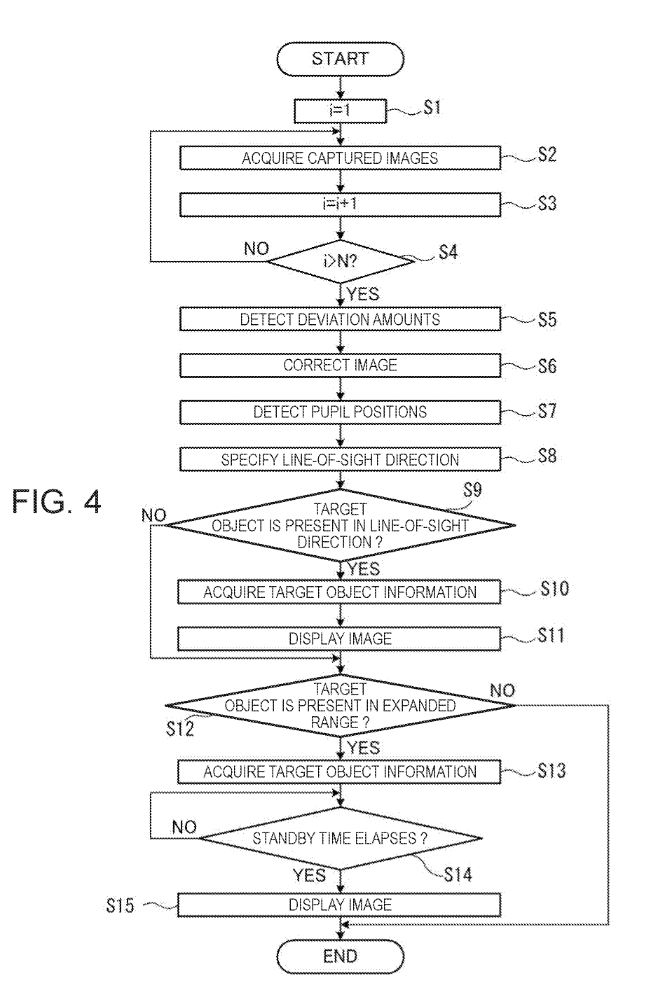

FIG. 4 is a flowchart for explaining a flow of the AR display processing. FIG. 5 is a diagram showing an example of a range in which AR display is performed in this embodiment. FIGS. 6 and 7 are examples of images displayed in the AR display processing in this embodiment.

In the HMD 1 in this embodiment, by operating the operation section 11 of the control section 10 in advance, the user is capable of choosing whether AR display concerning target object information is carried out and capable of choosing an image to be displayed as the target object information. When the user chooses to carry out the AR display and a type of the target object information to be display is selected, the HMD 1 carries out the AR display processing explained below. Note that an example is explained in which the user chooses to display a sugar content concerning a target object as the target object information.

When the AR display processing is carried out, first, the HMD 1 initializes a variable i indicating a spectral wavelength (i=1) (step S1). Note that the variable i is associated with a spectral wavelength of a measurement target. For example, when spectral images of lights having N spectral wavelengths λ1 to λN are captured as spectral measurement information, a spectral wavelength corresponding to the variable i is λi.

Subsequently, the imaging control section 169 causes the RGB camera 61 and the spectral camera 62 to acquire captured images (step S2). That is, the imaging control section 169 controls the RGB camera 61 and the spectral camera 62 and causes the RGB camera 61 to capture an outside scene image and causes the spectral camera 62 to capture a spectral image having the spectral wavelength λi.

The outside scene image and the spectral image are captured such that imaging timing are the same or a time difference between imaging timings is smaller than a preset time threshold. The outside scene image and the spectral image captured in step S2 is in the same imaging range R1 as shown in FIG. 5. The captured images acquired in step S2 are stored in the storing section 120.

Subsequently, the imaging control section 169 adds “1” to the variable i (step S3) and determines whether the variable i exceeds N (step S4). When determining No in step S4, the imaging control section 169 returns to step S2 and captures a spectral image having the spectral wavelength λi corresponding to the variable i and an outside scene image.

When it is determined Yes in step S4, this means that spectral images corresponding to all spectral wavelengths set as measurement targets are acquired. In this case, the deviation detecting section 163 detects deviation amounts of pixel positions of the acquired spectral images (step S5).

Specifically, the deviation detecting section 163 reads out outside scene images captured simultaneously with the spectral images and detects feature points (e.g., edge portions where luminance values are different by a predetermined value or more between pixels adjacent to each other) of the outside scene images. In this embodiment, the imaging range R1 of outside scene images captured by the RGB camera 61 and the imaging range R1 of spectral images captured by the spectral camera 62 are the same range. Therefore, positions (pixel positions) of the feature points of the outside scene images captured by the RGB camera 61 can be regarded as coinciding with pixel positions of the feature points in the spectral images.

Therefore, the deviation detecting section 163 detects, as positional deviation amounts, differences in positions between the feature points in the outside scene images captured at imaging timings of the spectral images. For example, it is assumed that a feature point is detected in (x1, y1) in an outside scene image captured simultaneously with a spectral image having a wavelength λ1 and a feature point is detected in (x2, y2) in an outside scene captured simultaneously with a spectral image having a wavelength λ2. In this case, a positional deviation amount between the spectral image having the wavelength λ1 and the spectral image having the wavelength λ2 is calculated as {(x2−x1)²+(y2−y1)²}^{1/2}.

Note that, as an image serving as a reference of a deviation amount, any outside scene image acquired in step S2 maybe used. For example, when a spectral image and an outside scene image corresponding to the variable i=1 are captured, the outside scene image may be set as a reference image to calculate deviation amounts of spectral images. An outside scene image corresponding to a variable i=N captured last may be set as the reference image. The reference image is not limited to the outside scene image acquired in step S2. For example, an outside scene image captured by the RGB camera 61 at present (timing after steps S1 to S4) may be set as the reference image to calculate the deviation amounts. That is, the deviation amounts of the spectral images with respect to the present outside scene image may be calculated on a real-time basis.

The spectral-image correcting section 164 corrects the positional deviations of the spectral images on the basis of the deviation amounts detected (calculated) in step S5 (step S6). That is, the spectral-image correcting section 164 corrects the pixel positions of the spectral images such that the feature points coincide in the spectral images.

Subsequently, the line-of-sight specifying section 161 acquires pupil positions in the left and right eyes of the user detected by the pupil detection sensors 63 (step S7) and specifies the line-of-sight direction D1 of the user on the basis of the pupil positions (step S8).

For example, when the pupil detection sensors 63 irradiate infrared rays on the eyes of the user and detect pupil positions corresponding to reflection positions of the infrared rays on the corneas, the line-of-sight specifying section 161 specifies the line-of-sight direction D1 (see FIGS. 5 and 6) as explained below. That is, when the positions of the infrared rays irradiated from the pupil detection sensors 63 are, for example, center points on the corneas of eyeballs, the line-of-sight specifying section 161 assumes that points at, for example, 23 mm to 24 mm (a diameter dimension of an average eyeball) in the normal direction (the eyeball inner side) from reflection positions of the infrared rays are reference points on the retinas. The line-of-sight specifying section 161 specifies a direction from the reference points toward the pupil positions as the line-of-sight direction D1.

After specifying the line-of-sight direction D1, as shown in FIGS. 5 and 6, the line-of-sight specifying section 161 may cause the image display section 20 to display a mark image indicating the line-of-sight direction D1. In this case, by viewing the line-of-sight direction D1, the user can also change the line of sight to adjust the line-of-sight direction D1 to a desired target object.

Thereafter, the image determining section 162 determines whether a displayable target object is present on the line-of-sight direction D1 specified instep S8 (step S9).

In step S9, for example, the image determining section 162 captures an outside scene image with the RGB camera and carries out pattern matching on an image on the line-of-sight direction D1 in the outside scene image. Note that an image determining method in the image determining section 162 is not limited to the pattern matching. For example, the image determining section 162 may detect an edge portion surrounding a pixel corresponding to the line-of-sight direction D1 and specify a target object surrounded by the edge portion as the first target object O1 (see FIGS. 5 to 7). In this case, when an edge portion surrounding the pixel corresponding to the line-of-sight direction D1 in the outside scene image is absent around the pixel (within the preset extended range R2), the image determining section 162 determines that a target object is absent in the line-of-sight direction D1 (No in step S9).

For example, in the example shown in FIGS. 5 to 7, an outside scene SC transmitted through the optical-image display sections 26 and 28 of the image display section 20 is visually recognized by the user. The outside scene SC includes the first target object O1 (in this example, grapes) in the line-of-sight direction D1. In this case, the image determining section 162 performs the pattern matching, the edge detection, or the like explained above on a target object located in the line-of-sight direction D1 from an outside scene image captured by the RGB camera 61 and recognizes the first target object O1.

When it is determined Yes in step S9, the target-object-information acquiring section 165 specifies, from the spectral images, pixel positions of the spectral wavelengths corresponding to a pixel position of the specified first target object O1 and acquires target object information concerning the first target object O1 on the basis of gradation values in the pixel positions of the spectral image (step S10).

For example, a sugar content of the first target object O1 is displayed as target object information, the target-object-information acquiring section 165 calculates light absorbance in the pixel position of the first target object O1 on the basis of a spectral image having a spectral wavelength corresponding to an absorption spectral of sugar among the spectral images and calculates a sugar content on the basis of the light absorbance. The target-object-information acquiring section 165 generates image information (first AR information P1) indicating the calculated sugar content and stores the image information in the storing section 120.

Thereafter, the image-position control section 166 sets, in the pixel position corresponding to the line-of-sight direction D1 in the outside scene image, a position of the first AR information P1 indicating the target object information generated instep S10. The display control section 168 causes the image display section 20 to display (AR-display) an image in the set position (step S11). For example, as shown in FIG. 6, the image-position control section 166 causes the image display section 20 to display, in the pixel position corresponding to the line-of-sight direction D1 or the vicinity of the line-of-sight direction D1, a numerical value indicating the sugar content of the first target object O1 (the grapes) as the first AR information P1 of a character image. At this time, according to the present position of the user and the distance to the position of the first target object O1, for example, as the distance is closer, the image-position control section 166 may display the first AR information P1 larger or increase the luminance of the first AR information P1 to be displayed.

When determining No in step S9 or after the display control section 168 causes the image display section 20 to display the image indicating the target object information concerning the first target object O1 in step S11, the image determining section 162 determines whether a target object (a second target object O2) is present within the predetermined extended range R2 set in advance centering on the line-of-sight direction D1 (step S12). Note that, as the determination of presence or absence of a target object, the same processing as step S9 is performed.

When it is determined Yes in step S12, as in step S10, the target-object-information acquiring section 165 acquires target object information concerning the detected second target object O2 (step S13). In step S13, the same processing as step S10 is performed. The target-object-information acquiring section 165 acquires the target object information concerning the second target object O2 and generates image information (second AR information P2) of the second target object O2.

The image-position control section 166 and the display control section 168 determine whether an elapsed time from the display of the first AR information P1 exceeds a preset standby time (step S14).

When determining No in step S14, the image-position control section 166 and the display control section 168 stay on standby until the standby time elapses (repeats the processing in step S14). When determining Yes in step S14, the image-position control section 166 sets a position of the second AR information P2 generated in step S13 in a pixel position corresponding to the second target object O2 in the outside scene image. The display control section 168 causes the image display section 20 to display the second AR information P2 in the set position (step S15).

Consequently, from a state in which only the first AR information P1 concerning the first target object O1 shown in FIG. 6 is displayed, a region AR-displayed after the elapse of the predetermined standby time is enlarged to the extended range R2. As shown in FIG. 7, the second AR information P2 concerning the second target object O2 present around the first target object O1 is displayed.

After step S15 or when it is determined No in step S12, the AR display processing is ended.

Action and Effects of this Embodiment

In the HMD 1 in this embodiment, the pupil detection sensors 63 that detect the pupil positions of the eyes of the user are provided in the image display section 20. The line-of-sight specifying section 161 specifies the line-of-sight direction D1 on the basis of the detected pupil positions. The target-object-information acquiring section 165 acquires the target object information concerning the first target object O1 on the line-of-sight direction D1 using the spectral images having the spectral wavelengths captured by the spectral camera 62. The image-position control section 166 and the display control section 168 cause the image display section 20 to display the image information (the first AR information P1) indicating the acquired target object information in the position corresponding to the first target object O1.

Consequently, in this embodiment, it is possible to AR-display the target object information concerning the first target object O1 present in the line-of-sight direction D1 of the user, that is, a target object currently focused on by the user in the outside scene SC within the visual field of the user. A target object around the first target object O1 is not AR-displayed. Therefore, for example, compared with when target object information concerning all target objects within the imaging range R1 is AR-displayed at a time, the user can easily confirm the target object information concerning the target object focused on by the user (the first target object O1). It is possible to appropriately provide necessary information to the user.

The target-object-information acquiring section 165 only has to analyze only portions corresponding to the first target object O1 on the line-of-sight direction D1 in the spectral images and acquire target object information. Therefore, compared with when target object information concerning all target objects included in the imaging range R1 is acquired, it is possible to easily acquire the target object information.

For example, in the embodiment, the sugar content of the target object is displayed. However, in order to display sugar contents of all the target objects within the imaging range R1, it is necessary to detect all the target objects within the imaging range R1 and calculate sugar contents of the respective target objects on the basis of pixel values of spectral images in pixel positions corresponding to the respective target objects. In this case, a processing load increases and a time until the display of the target object information also increases. On the other hand, in this embodiment, the target object information concerning the first target object O1 on the line-of-sight direction D1 only has to be acquired. Therefore, it is possible to achieve a reduction in the processing load and quickly AR-display a target object focused on by the user.

In this embodiment, after causing the image display section 20 to display the target object information concerning the first target object O1 on the line-of-sight direction D1, according to the elapse of time, the target-object-information acquiring section 165 acquires the target object information concerning the second target object O2 included in the predetermined extended range R2 centering on the line-of-sight direction D1 and causes the image display section 20 to display the target object information.

In this case as well, when the target object information concerning the first target object O1 is displayed, the target object information concerning the second target object O2 is not acquired. Therefore, the increase in the processing load in displaying the target object information concerning the first target object O1 is suppressed. The target object information concerning the first target object O1 is easily seen. It is possible to improve convenience for the user.

When the predetermined elapsed time (standby time) elapses after the display of the target object information concerning the first target object O1, the target object information concerning the second target object O2 around the first target object O1 is also displayed. Consequently, it is possible to display target object information concerning a plurality of target objects in the extended range R2. At this time, since the target object information concerning the first target object O1 located in the line-of-sight direction D1 is displayed earlier, it is not hard to visually recognize a display position of the target object information concerning the first target object O1 focused on most by the user.

In this embodiment, spectral images corresponding to a plurality of spectral wavelengths are acquired in order while sequentially switching a spectral wavelength. In this case, when the head position of the user moves at imaging timings of the spectral images, pixel positions deviate with respect to a target object in the spectral images. On the other hand, in this embodiment, outside scene images are captured by the RGB cameras 61 simultaneously with the imaging timings of the spectral images, feature points of the outside scene images are detected, and deviation amounts of pixels at the imaging timings of the spectral images are detected. The spectral images are corrected on the basis of the detected deviation amounts such that the pixel positions of the spectral images coincide.

Consequently, it is possible to accurately detect received light amounts of lights having spectral lengths on a target object. It is possible to accurately calculate a sugar content of target object information with the target-object-information acquiring section 165.

As the detection of deviation amounts, feature points of spectral images may be respectively extracted and corrected to coincide with one another. However, in the spectral images, detectable feature points and undetectable feature points (or feature points with low detection accuracy) are included depending on the spectral wavelengths. Therefore, when the feature points are extracted from the spectral images and corrected, correction accuracy decreases. On the other hand, when feature points are extracted on the basis of outside scene images captured simultaneously with the spectral images, it is possible to extract feature points of the outside scene images at timings at substantially the same detection accuracy. Therefore, by detecting deviation amounts on the basis of the feature points of the outside scene images, when positional deviation of the spectral images is corrected, it is possible to perform highly accurate correction.

### Second Embodiment

In the first embodiment, the deviation detecting section 163 detects the deviation amounts of the spectral images on the basis of the outside scene images captured simultaneously with the spectral images. On the other hand, a second embodiment is different from the first embodiment in a detection method for a deviation amount by a deviation detecting section.

Note that, in the following explanation, the components explained above are denoted by the same reference numerals and signs and explanation of the components is omitted or simplified.

The HMD 1 in the second embodiment includes substantially the same configuration as the HMD 1 in the first embodiment. Processing of the deviation detecting section 163, which functions when the CPU 140 reads out and executes a computer program, is different from the processing in the first embodiment.

The deviation detecting section 163 in this embodiment detects deviation amounts of spectral images on the basis of a detection signal output from the nine-axis sensor 64. Therefore, in this embodiment, it is unnecessary to capture outside scene images with the RGB camera 61 at imaging timings of the spectral images. That is, in this embodiment, in step S2 in FIG. 4, instead of the imaging processing of the outside scene images by the RGB camera 61, the detection signal output from the nine-axis sensor 64 is acquired.

In step S5 in FIG. 4, the deviation detecting section 163 detects, on the basis of a detection signal output by the nine-axis sensor 64, as deviation amounts, displacement amounts of the position of the image display section 20 at timings when the spectral images are captured. For example, the deviation detecting section 163 calculates, as a deviation amount, a displacement amount of the image display section 20 on the basis of a detection signal of the nine-axis sensor 64 at timing when the spectral image having the spectral wavelength λ1 is captured and a detection signal of the nine-axis sensor 64 at timing when the spectral image having the spectral wavelength λ2 is captured.

The other components and the image processing method are the same as those in the first embodiment. After the pixel positions of the spectral images are corrected on the basis of the deviation amounts detected by the deviation detecting section 163, target object information concerning target objects present in the line-of-sight direction D1 and the extended range R2 is displayed.

### Action and Effects of the Second Embodiment

In this embodiment, when detecting the deviation amounts of the pixel positions of the spectral images, the deviation detecting section 163 calculates the displacement amount of the position of the head of the user (the image display section 20) based on the detection signal output from the nine-axis sensor 64.

In this case, it is unnecessary to capture outside scene images at the imaging timings of the spectral images. It is possible to reduce a processing load required for the imaging processing. It is possible to accurately detect the deviation amounts. That is, when the deviation amounts are detected on the basis of feature points of images, a processing load is required for detection of the feature points because, for example, differences of luminance values among pixels of the images are calculated. When detection accuracy of the feature points is low, detection accuracy of the deviation amounts also decreases. On the other hand, in this embodiment, an actual displacement amount of the image display section 20 is detected by the nine-axis sensor 64. Therefore, the detection accuracy of the deviation amounts is high. It is possible to reduce the processing load required for the image processing.

### Modifications

Note that the invention is not limited to the embodiments explained above. Modifications, improvements, and the like in a range in which the object of the invention can be achieved are included in the invention.

In the first embodiment, in step S5, the deviation amounts of the spectral images with respect to the currently captured outside scene image may be detected on a real-time basis. In this case, in the correction processing in step S6 as well, it is possible to adjust the pixel positions of the spectral images to the currently captured outside scene image on a real-time basis. In this case, the position of the first target object O1 in the spectral images is also updated on a real-time basis. It is possible to more accurately display the target object information concerning the first target object located on the line-of-sight direction D1.

The example is explained in which, in step S9, the first target object O1 is detected by the image determining section 162. However, the invention is not limited to this.

For example, a sugar content in a pixel coinciding with the line-of-sight direction D1 may be analyzed by the image determining section 162 on the basis of the spectral images acquired in step S2 irrespective of whether a target object is present. In this case, when the sugar content can be analyzed from the pixel, the image determining section 162 determines that a substance containing sugar is present, that is, the first target object O1 is present and displays target object information (the first AR information P1) indicating the sugar content in a pixel position corresponding to the line-of-sight direction D1 (e.g., a position overlapping the line-of-sight direction D1 or a near position in a predetermined pixel range from the line-of-sight direction D1). On the other hand, when the sugar content with respect to the line-of-sight direction D1 cannot be analyzed from the spectral images, for example, the image determining section 162 determines that the first target object O1 is absent in the line-of-sight direction D1.

In such processing, it is possible to omit processing for detecting a target object with respect to an outside scene image. It is possible to more quickly display image information of target object information.

In the first embodiment, the example is explained in which, in the processing in steps S12 to S15, after the predetermined standby time elapses, the target object information of the second target object O2 is displayed. However, the invention is not limited to this.

For example, processing for, after displaying the first AR information P1 concerning the first target object O1, according to an elapsed time, displaying the second AR information P2 concerning the second target object O2 in order in ascending order of the distance from the first target object O1.

In this case, for example, when a large number of second target objects O2 are present, target object information concerning all the second target objects O2 is not displayed at a time. Therefore, for example, it is possible to prevent an inconvenience that, for example, the user loses sight of the first AR information P1 concerning the first target object O1.

In the first embodiment, the information indicating the sugar content of the target object is illustrated as the target object information. However, the invention is not limited to this. Various kinds of information can be displayed as the target object information. For example, various components such as protein, lipid, and moisture content may be calculated on the basis of the spectral images and displayed as the target object information. The spectral images to be acquired are not limited to a visible light region to an infrared region. An ultraviolet region and the like may be included. In this case, it is also possible to display a component analysis result for the ultraviolet region.

As the target object information, a spectral image corresponding to a predetermined spectral wavelength of the target object may be superimposed and displayed on the target object. In that case, it is more desirable to display the spectral image in 3D (image display with a parallax between an image for the right eye and an image for the left eye) and display the target object and the spectral image to overlap in each of the right eye and the left eye.

Further, as the target object information, various kinds of information acquired via the Internet and the like, for example, a name of the target object may also be displayed. For example, a position of the target object acquired by the GPS module 134 may be also be displayed. That is, as the target object information, information based on information other than the spectral measurement information may also be displayed.

In the first embodiment, the example is explained in which the spectral images in the imaging range R1 are captured by the spectral camera 62. However, the invention is not limited to this.

For example, the spectral camera 62 maybe configured to capture spectral images in a predetermined range including the line-of-sight direction D1 (e.g., the extended range R2). In this case, spectral images corresponding to a range in which the AR display is not carried out (a range other than the extended range R2 in the imaging range R1) are not acquired. Therefore, it is possible to reduce an image size of the spectral images. When the target-object-information acquiring section 165 analyzes the spectral images and acquires the target object information, an image size of spectral images to be read out decrease and a detection range of the target object also decreases. Therefore, it is also possible to reduce a processing load required for acquisition processing for the target object information.

Besides, a specific structure in carrying out the invention can be changed to other structures and the like as appropriate in a range in which the object of the invention can be achieved.

The entire disclosure of Japanese Patent Application No. 2017-064544 filed Mar. 29, 2017 is expressly incorporated herein by reference.

What is claimed is:

1. A head mounted display comprising:
a pupil detecting sensor adapted to detect pupil positions of a user;
a spectral measurer adapted to acquire spectral measurement information of a first target object in a scene within a visual field of the user based on a line-of-sight direction of the user;
a display section adapted to display a first target object information in a position corresponding to the first target object in the scene; and
a controller configured to specify the line-of sight direction of the user on the basis of the pupil positions, and configured to acquire the first target object information concerning to the first target object on the basis of the spectral measurement information.

2. The head mounted display according to claim 1, wherein
the spectral measurer acquires the spectral measurement information in a predetermined range of the scene,
the controller acquires second target object information concerning a second target object within the predetermined range, and
the display section displays the first target object information in the position corresponding to the first target object and thereafter displays, according to elapse of time, displays the second target object information in a position corresponding to the second target object in the scene.

3. The head mounted display according to claim 1, wherein
the spectral measurer includes a spectral element adapted to disperse incident light and an imager configured to image lights dispersed by the spectral element, the imager obtains spectral images as the spectral measurement information, and
the controller configured to detect deviation amounts of imaging positions at a time when the spectral wavelength is changed by the spectral element, and configured to correct the deviation amounts in the spectral images having a plurality of wavelengths.

4. The head mounted display according to claim 3, wherein
and the imaging section includes a camera;
the controller detects the deviation amounts from positions of feature points of the scene captured by the camera at timing when any one of the spectral images having the plurality of wavelengths is acquired.

5. The head mounted display according to claim 4, wherein the camera is an RGB camera.

6. The head mounted display according to claim 3, further comprising a displacement detection sensor adapted to detect displacement of a position of the head mounted display, wherein
the controller detects the deviation amounts on the basis of a displacement amount detected by the displacement detection sensor.
